(19) United States
(12) Patent Application Publication
(10) Pub. No.: US 2006/0201018 A1
(43) Pub. Date: Sep. 14, 2006

(54) System, apparatus and method for curing of coatings in heavy gas

(76) Inventors: Kevin McKay, Spring, TX (US); Harrell Page Ellis, Irving, TX (US); Gregory Page Ellis, New Braunfels, TX (US)

Correspondence Address: George R. Schultz;Schultz & Associates, P.C., One Lincoln Centre, 5400 LBJ Freeway, Suite 1200, Dallas, TX, 75240, US

(21) Appl. No.: 11/247,607

(22) Filed: Oct. 10, 2005

Related U.S. Application Data
(63) Continuation-in-part of application No. 11/077,073, filed on Mar. 10, 2005.

(51) Int. Cl. F26B 3/34

(52) U.S. Cl. 34/276; 522/148

(57) ABSTRACT

A system, apparatus and method is provided for curing ultraviolet (UV) curable coatings on articles using UV lamps while the article is immersed in an atmosphere if inert gas heavier than air. An example of an apparatus provided by the invention includes a flat table including a flat bar conveyor, a curing chamber dynamically sealed by gas knives and pivotally removable ultraviolet lamp assemblies for curing coatings in the absence of ambient air.

### CROSS-REFERENCES TO RELATED APPLICATIONS

This application is a continuation-in-part of U.S. application Ser. No. 11/077,073 filed Mar. 10, 2005.

### FIELD OF THE INVENTION

The present invention relates generally to the application of curable coatings to articles and more particularly to a curing apparatus utilizing ultraviolet radiation for curing coatings applied to multifaceted articles, such as cabinet doors, in an atmosphere of inert gas that has the property of being heavier than air.

### BACKGROUND OF THE INVENTION

Processes utilizing light radiation to cure coatings on articles have become established and important commercial processes. They have benefited from a trend away from environmentally unfriendly processes such as solvent based curing. Since many radiation curably coatings can cure quickly, they are useful in continuous and high speed applications where high output is essential to success in the market place. Examples of products which are now made routinely with such processes are graphic arts, wood panels, furniture parts, optical fibers and electrical components.

Ultraviolet light (UV) is the radiation source most frequently used to cure coatings and accounts for a majority of the volume of products produced. UV curing is a photochemical process by which monomers having photoinitiators undergo polymerization or cross-linking upon exposure to the ultraviolet radiation. The rate of curing depends on the chemical composition of the coating, the thickness of the coating, the radiation intensity and the chemical composition of the atmosphere surrounding the part to be cured.

The chemical composition of the coating is generally an organic resin combined with a light curing acrylate. Organic resins useful in the present invention include those with a radiation hardendable components used as bonding agents. Bonding agents contain radical or cation polymerizable chemical groups. In the preferred embodiment, examples of the organic resins include vinylether, vinylamide with maleic acid or fumaric acid and styrene as reactive solvents. In the preferred embodiment, examples of UV curing acrylates are polyester (meth)-acrylates, polyether (meth) acrylate, urethane (meth) acrylate, epoxi (meth) acrylate, silicon (meth) acrylate. Concentrations preferred are 40 mol percent to 60 mol percent radiation hardenable organic resin per (meth) acrylate group. Other reactive groups include melamin, isocyanate, epoxy, anhydride, alcohol, groups of carbonic acids for additional thermal hardening. Chemical reaction hardening can also be used in part by substitution of alcohol, carbonic acid, amine, epoxy, anhydride, isocyanates and other methyl groups contained in a binary cure process.

The presence of oxygen can have a detrimental effect on the curing process known as oxygen inhibition. Oxygen reacts with free radicals and forms peroxy radicals by reaction with the photoinitiator, monomer or propagating chain radical. The reactivity of the peroxy radical becomes insufficient to continue the polymerization process, leading to chain termination and incomplete curing.

One method of overcoming oxygen inhibition is curing in an inert gas atmosphere. Industrial processes generally require that the inert gas be heavier than air. The molar weight of the gas should be larger than 28.8 grams per mol and preferably larger than 32 grams per mol (oxygen and 80% nitrogen correspond in the molecular weight of a gas mixture of 20%, for instance). An inert gas atmosphere comprised of noble gases such as argon, hydrocarbon and halogen gases is also acceptable. Carbon dioxide (CO₂) is particularly suitable for use in providing an inert gas atmosphere to overcome oxygen inhibition. CO₂ can be conveniently stored in liquid form and transported in metal cylinders at normal room temperature.

Methods and apparatus relating to the use of CO₂ gas in curing certain coatings with UV radiation has been described in German patent DE19957900A1 to Beck et al., U.S. Pat. No. 3,956,540 to Laliberte et al., U.S. Pat. No. 4,436,764 to Nakazima et al., U.S. Pat. No. 4,862,827 to Getson, and U.S. Pat. No. 6,620,251 to Kitano.

The use of CO₂ gas when curing certain coatings using UV radiation has also been described in PCT application PCT/EP00/11589 to Beck, et al., titled “Light Curing of Radiation Curable Materials under a Protective Gas”. The process described by Beck, et al., however, is not easily adapted to a high volume, production environment.

The UV lamps, reflective surfaces and other optical components making up the curing system directly affect the amount of UV energy that encounters the curing surface. During production, various deposits can accumulate on the optical components that can greatly lessen the efficiency of the system. Currently, most systems, such as Beck, et al., do not provide for easy replacement, cleaning or maintenance of the optical components of the system.

What is needed, therefore, is a curing system and method used for hardening UV curable coatings in an inert gas while also having the capability of maintaining high production volumes.

It is further desirable for a curing system and method to permit the operator to easily access the required optical components to allow efficient replacement, cleaning, and/or general maintenance.

It is further desirable that a curing system and method be adapted to provide for rapid delivery of a large volume of inert gas to the apparatus evenly by a gas distribution means.

It is further desirable to provide a curing system adapted to allow a linear curing path without doors or changes in elevation in the curing path to increase the number of articles cured by the device per time.

### BRIEF DESCRIPTION OF THE DRAWINGS

The feature characteristics of the present are set forth in the appended claims. The invention itself however, as well as a preferred mode of use, further objects, and advantages thereof, are best understood by reference to the following detailed description when read in conjunction with the accompanying drawings, wherein:

FIG. 1 is an isometric view of the curing apparatus.

FIG. 2 is a partial side view of the curing apparatus.

FIG. 3 is a partial side view of the curing apparatus.

FIGS. 4a-4c show various views of an air knife of the invention in one preferred embodiment.

FIG. 5 shows the one preferred embodiment of the gas distribution system of the invention.

FIG. 6a shows a partial pictorial view of a UV lamp assembly in one preferred embodiment of the invention.

FIG. 6b shows a cutaway side view of a preferred embodiment of a UV lamp assembly of the invention.

FIG. 7 shows the electrical architecture of a preferred embodiment of the invention.

FIG. 8 shows the steps initiated by the electronic microcontroller in one preferred embodiment of the invention.

FIG. 9 is a partial bottom view of the curing apparatus.

### DETAILED DESCRIPTION

The present invention is described in this specification in terms of a device and a method for using the device. The invention may be made and the method carried out in different configurations or alternate embodiments without deviating from the spirit and scope of the invention which is defined only by the appended claims.

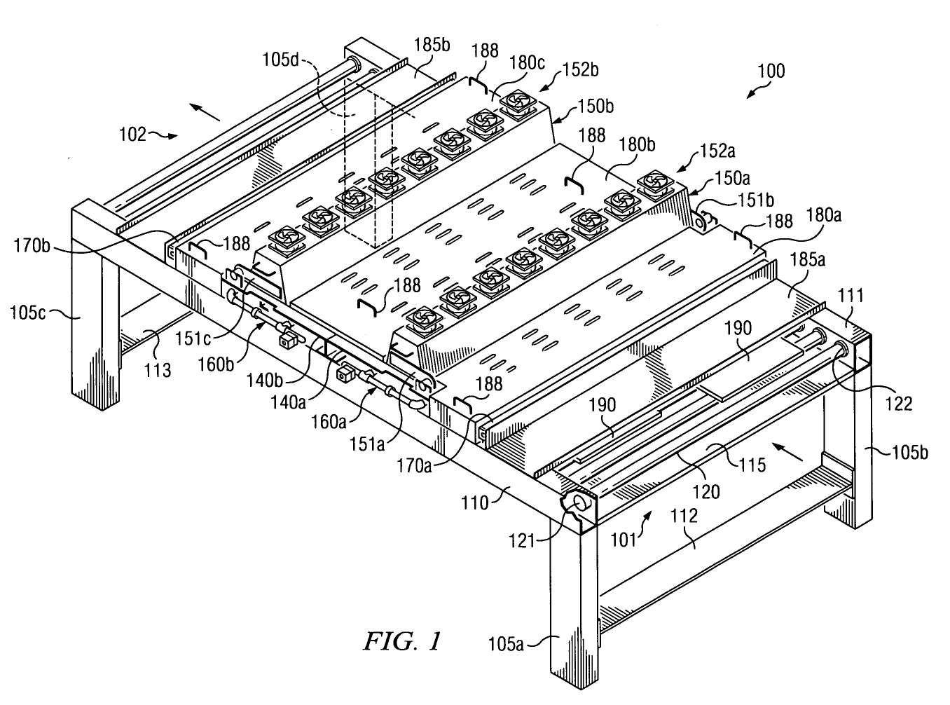

FIG. 1 shows an isometric view of the curing apparatus 100. Channels 110 and 111 are welded to a set of four table legs 105a-105d. The channels are attached to a flat table panel 115 across their full length to form a solid platform. In the preferred embodiment, the channels have a square cross section. But in other embodiments, differently shaped cross sections will also function equally as well. Support cross members 112 and 113 are mounted between the table legs. In the preferred embodiment, the channels, table panel, table legs and crossmembers are constructed of mild strength steel. Of course, other heat resistant rigid materials will suffice.

Steel roller bars 120 are mounted perpendicularly along the length of the channels. Suitable bearing blocks 121 and 122 are fitted in both channels to support the roller bars. In the preferred embodiment the roller bars 120 are approximately 2″ in diameter and spaced approximately 4″ apart. Of course, other dimensions and spacings will serve as well in other embodiments. In yet other embodiments, fixed roller and bar conveyors can be used in commercially available dimensions.

During operation of the device, the roller bars function to move a set of planar objects 190 from entrance 101 under baffle plates 185a and 185b and UV light assemblies 150a and 150b and to exit 102. In the preferred embodiment the objects are planner but objects of other shapes are also accommodated by the invention.

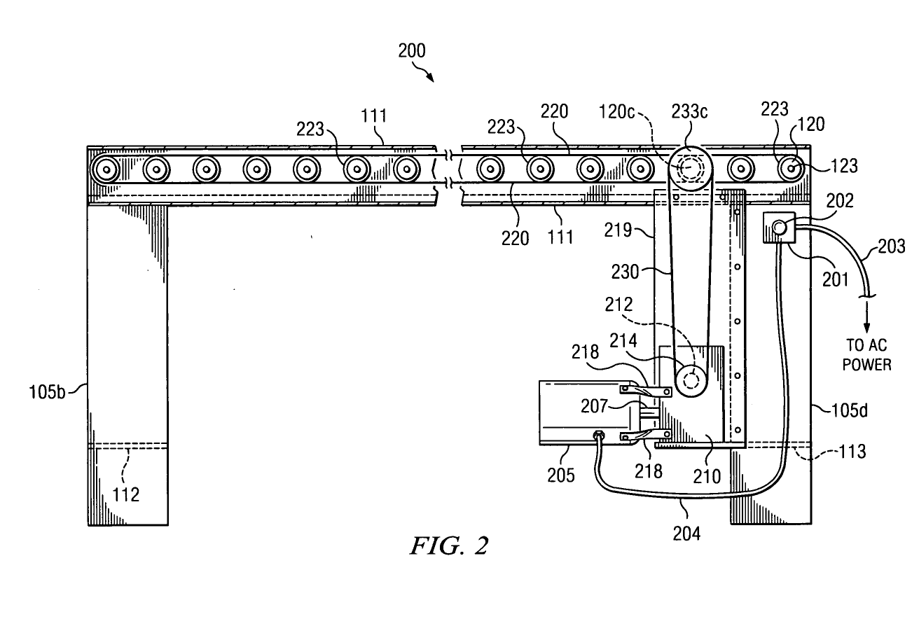

In order to move planar objects 190 from the entrance to the device to the exit, a drive system is provided to impart rotation to the roller bars. Turning to FIG. 2, the table roller drive 200 is shown. Each roller bar 120 has a reduced diameter gear shaft 123 which extends through a corresponding hole in channel 111. A single drive sprocket 223 is attached to each gear shaft. A drive chain 220 connects the drive sprockets together so that the roller bars can be made to rotate in unison. A primary drive sprocket 233c is attached to the gear shaft of roller bar 120c. The primary drive sprocket is connected by drive chain 230 to gear 214 which is attached to the axle 212 of a reduction gearbox 210. Reduction gearbox 210 is driven by drive motor 205 through motor axle 207. The combination of reduction gearbox 210 and drive motor 205, which are connected by mount brackets 218, are attached to drive mount bracket 219 which is in turn bolted to table leg 105d and channel 111. Drive motor 205 is electrically connected via power connection 204 to motor control unit 201 which includes a start/stop switch 202. Motor control unit 201 powers the motor 205 via connection to outside AC power 203. In another preferred embodiment the drive chain and drive sprockets are replaced with a notched reinforced rubber belt and associated toothed sprockets.

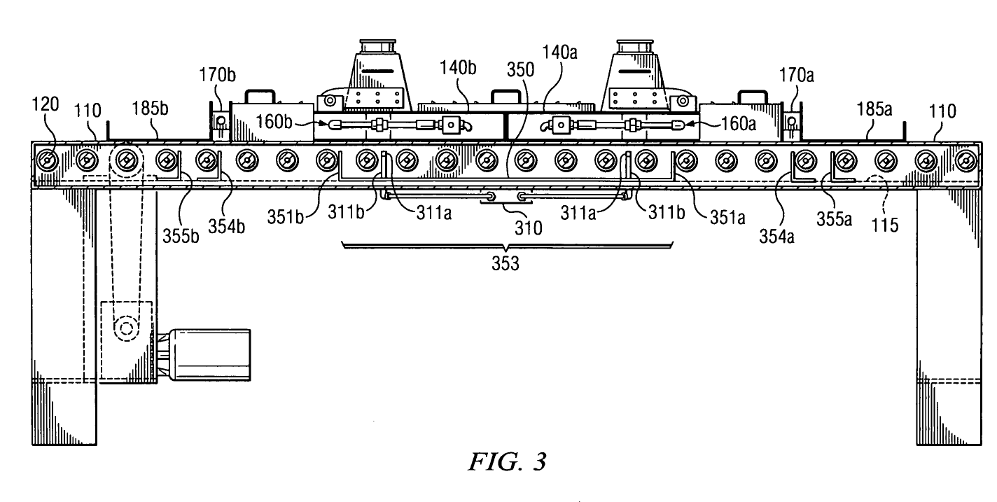

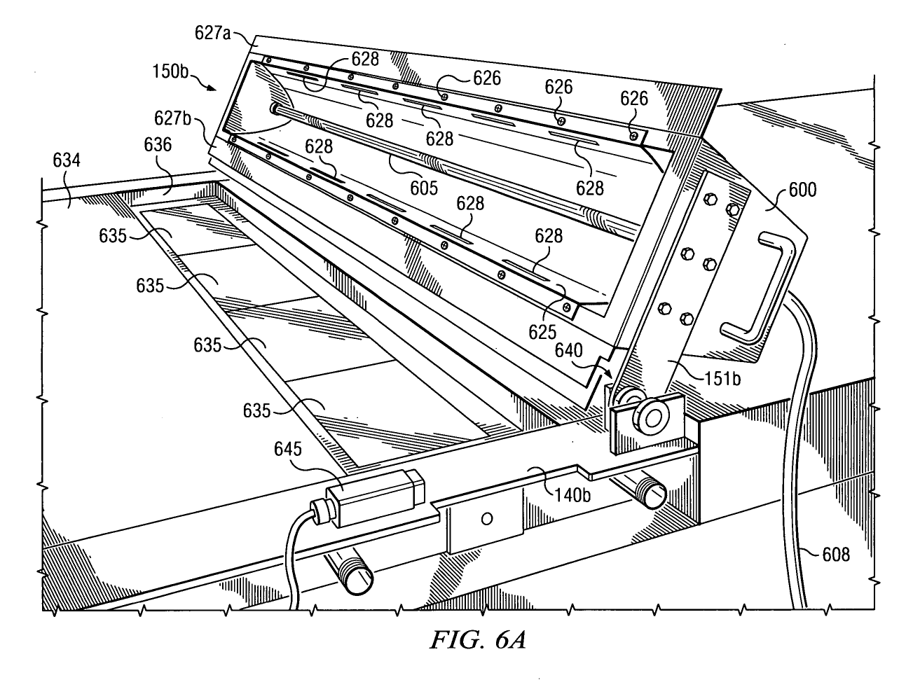

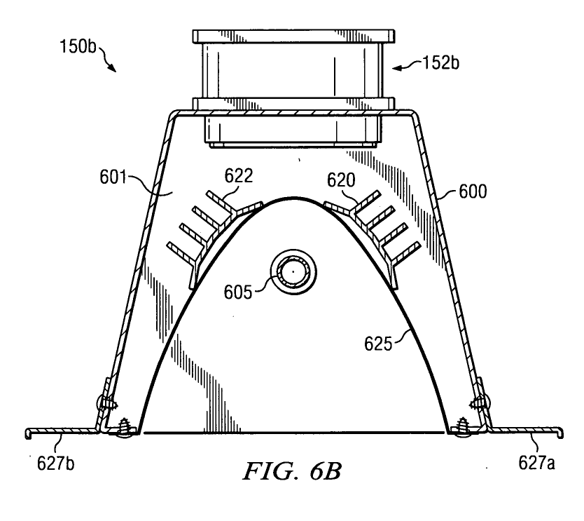

As shown best in FIGS. 1 and 6a, the UV curing function of the curing apparatus 100 is accomplished by a set of components that are fastened to channels 110 and 111 and table panel 115, as can best be seen in FIGS. 1 and 3. Lamp support housing 140a and lamp support housing 140b are positioned on channels 110 and 111. Each abuts a center tray 634 at the center of curing apparatus 100. The lamp support housings each form a frame which supports pivoting UV lamp assemblies 150a and 150b and an open tray into which fit crystal glass panes that allow illumination to pass from the UV lamp assemblies to the products on the roller bars below. In the preferred embodiment, the support housings are positioned directly against the channels. In an alternate embodiment (not shown), the support housings can be mounted at an angle with respect to the channels in order to facilitate different types of UV lamp assemblies or to provide different angles of incidence. The crystal glass panes and open tray associated with lamp support housing 140a are shown as 635 and 636, respectively. In an alternate embodiment, the crystal glass pane can be replaced by shutters placed lengthwise in the trays. The switches can be closed to allow presentation of the inert gas during periods of non-use or can be opened to allow light to pass. The sides of each housing form part of the curing chamber that contains the inert gas. UV lamp assembly 150a is fastened to lamp support housing 140a by lamp hinges 151a and 151b so that it can be rotated to an open position away from the center of curing apparatus 100. UV lamp assembly 150b is fastened to lamp support housing 140b by lamp hinges 151c and a second lamp hinge not shown in the drawings, so that it can be rotated to an open position away from the center of curing apparatus 100. The open position allows for easy maintenance and cleaning of the lamp assemblies and other optical components such as the glass panels and reflectors. Each UV lamp assembly can also be rotated into a closed position. When in a closed position, the UV lamp assemblies are positioned directly above the trays in the lamp support housings. The transparent glass substrate 635 positioned in the trays allows the transmission of UV light from the lamp assemblies while also forming the top of the curing chamber.

Curing processes require UV light radiation of significant intensity. These lamps generate excess heat which must be removed from the curing apparatus 100. Two rows of lamp cooling fans 152a and 152b are fitted to the top of UV lamp assemblies 150a and 150b to circulate air through said lamp assemblies to cool the UV lamps. Impellers or other sources of high pressure ambient air may be used in other embodiments. Refrigerated air may also be used to reduce the flow rate or volume of air needed to cool the lamps. Heat shields 180a, 180b and 180c are removably fitted to the top of lamp supports 140a and 140b to act as heat sinks and to protect operators from the hot surface of the lamp supports 140a and 140b. Handles 188 are mounted on the heat shields 180a-c to allow for ease of removal. In the preferred embodiment, there are eight cooling fans for each UV lamp assembly. Each fan operated at a flow rate of about 2 CFS in order to maintain an acceptable operating temperature of about 100 degrees Fahrenheit. Of course, other fan arrangements can function as well so long as they maintain the UV lamp assemblies at a stable operating temperature.

The UV curing process is inhibited by the presence of oxygen. Lamp support housings 140a and 140b, glass substrate 635, table panel 115, gas knives 170a and 170b, inner baffles 354a and 354b and baffle plates 185a and 185b form a curing chamber through which products may pass unhindered on the roller bars and be irradiated with UV light out of the presence of oxygen.

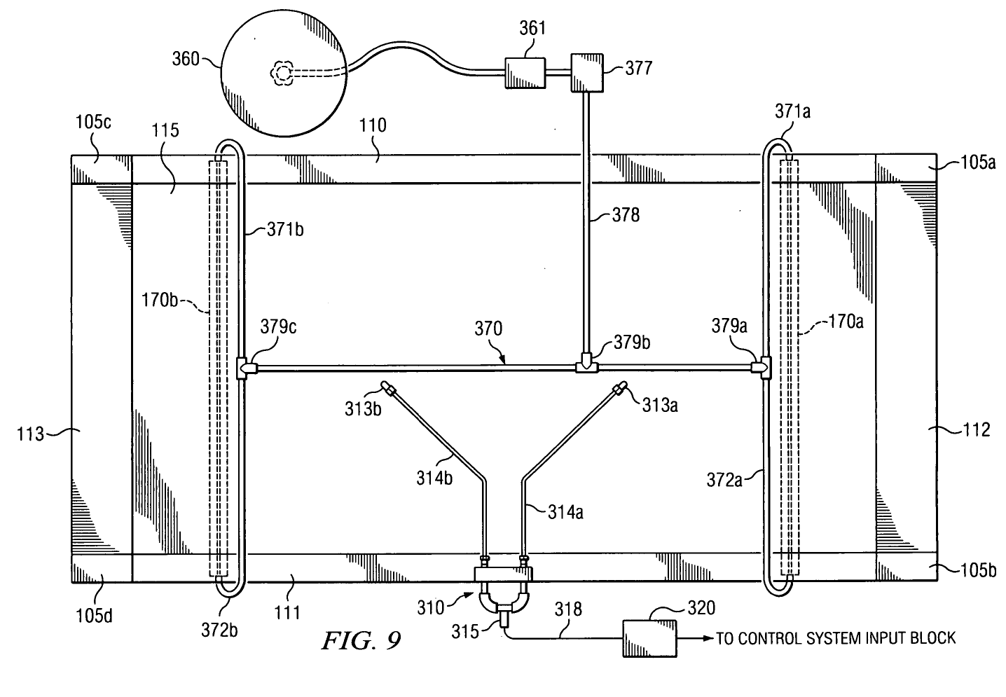

As shown best in FIGS. 3 and 9, a gas distribution system is placed within the curing chamber to provide a well distributed and constant supply of inert gas to the curing chamber to displace oxygen in the ambient atmosphere. The gas distribution system comprises a set of gas distribution assemblies for supplying gas to the curing chamber and to “gas knives” which form a positive pressure gas curtain at the entry and exit of the curing chamber.

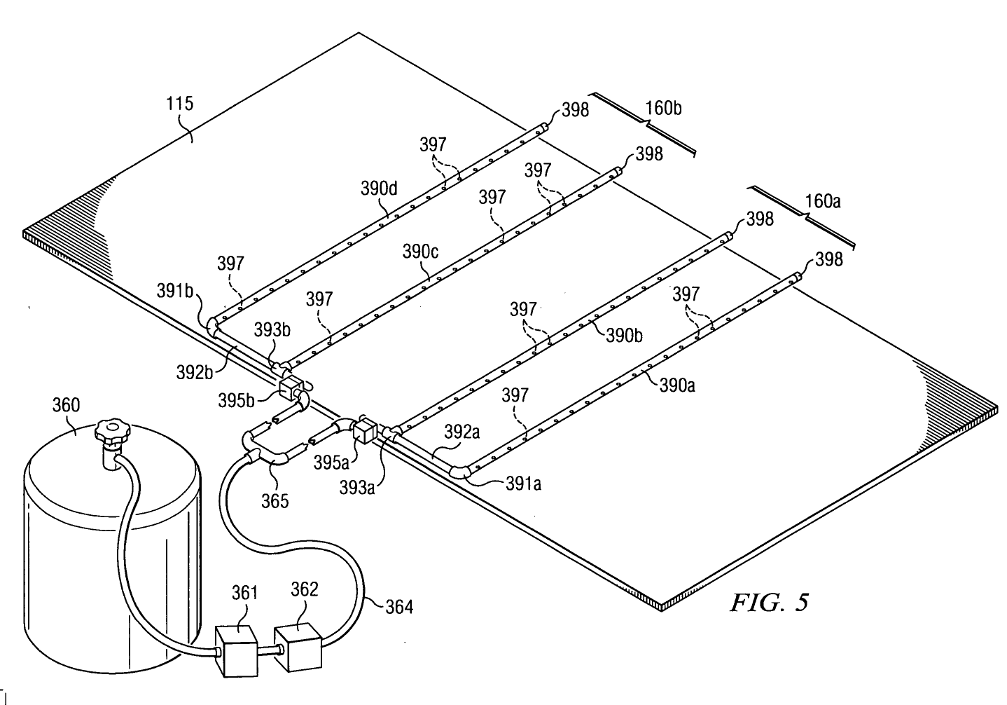

FIG. 5 shows the gas distribution assemblies 160a and 160b. Gas distribution assemblies 160a and 160b pass through and are supported by lamp supports 140a and 140b. The gas distribution assembly 160a is comprised of gas manifolds 390a and 390b connected by a series of pipe fittings. In particular, gas manifold 390a is connected to elbow 391a which connects to one end of connector pipe 392a. Gas manifold 390b is connected to tee fitting 393a which, in turn, connects to the other end of connector pipe 392a. Tee fitting 393a also connects to a solenoid valve 395a which is in turn connected to connector 365. Connector 365 connects to gas line 364 which is in turn connected to gas regulator 362. The gas distribution assembly 160b is comprised of gas manifolds 390c and 390d connected by a series of pipe fittings. In particular, gas manifold 390d is connected to elbow 391b which connects to one end of connector pipe 392b. Gas manifold 390c is connected to tee fitting 393b a which, in turn, connects to the other end of connector pipe 392b. Tee fitting 393b also connects to a solenoid valve 395b which is in turn connected to connector 365. Connector 365 connects to gas line 364 which is in turn connected to gas regulator 362. Gas regulator 362 connects to a gas control switch 361 which in turn is connected to a pressurized gas reservoir 360 through gas line 365. Gas reservoir 360 provides the source of gas for the gas distribution assemblies 160a and 160b. In the other embodiments, the gas distribution assemblies may utilize separate gas control switches and gas reservoirs.

Gas manifolds 390a and 390b span the width of table panel 115. They are capped by end caps 398 and have gas exit holes 397 to feed gas downward into the curing chamber. Each of the exit holes of the preferred embodiment is sized to provide a #20 natural gas orifice. In other embodiments, the holes can be graduated in diameter to provide a uniform flow rate which accounts for the pressure drop across the length of each manifold. Gas regulator 362 is typically set at a gas flow rate out of the distribution assembly in the range 300 CFH (cubic feet/hr). Solenoid valves 395a and 395b switches the flow of gas into the curing chamber and is electrically connected to a control unit (not shown).

The piping used for the gas distribution assemblies in the preferred embodiment is ¾″ AGA rated stainless steel gas pipe. Of course, other sizes and types of materials will suffice for differing flow rates and orifice sizes as is known in the art.

In the preferred embodiment, the gas supplied to the curing chamber is CO₂ because of its widespread availability and low cost. In other alternate embodiments, other gases such as nitrogen, argon, hydrocarbons, or halogenated hydrocarbons can be used.

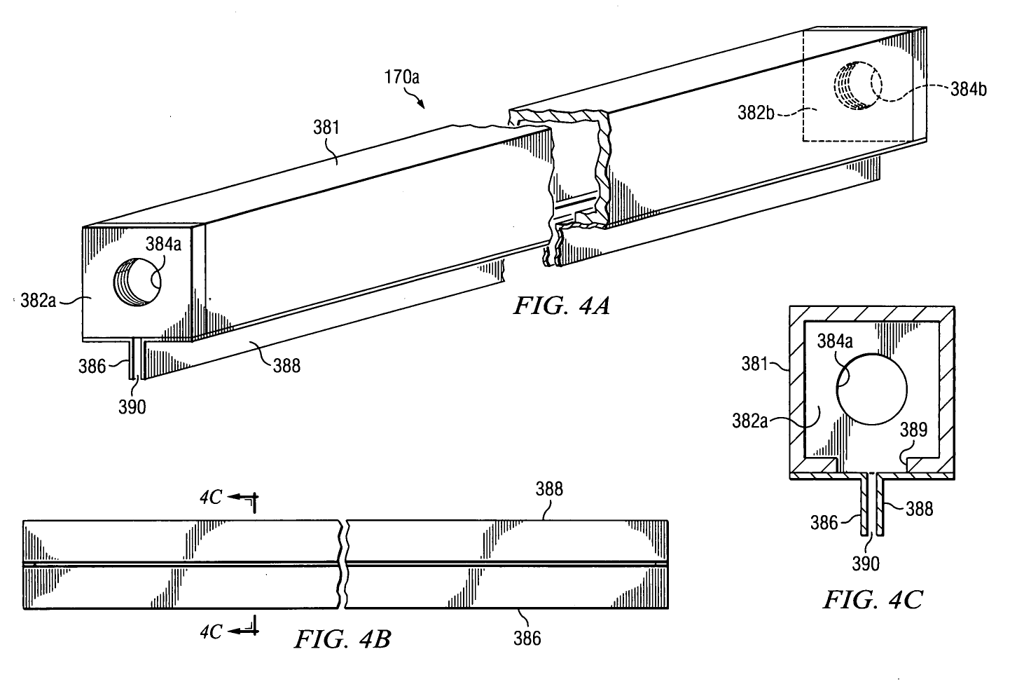

Moving to FIGS. 9 and 4a-4c, the gas knives and gas distribution assemblies for distribution of inert gas to the gas knives is shown. Gas knives 170a and 170b are attached to the entrance and exit sides of lamp supports 140a and 140b, respectively. Gas knives 170a and 170b are made of 2″ square steel tube 381 with endcaps 382a and 382b welded in place. In each endcap 382a and 382b are threaded holes 384a and 384b for attachment to gas lines 371a and 372a. The square steel tube 381 includes slot 389 lengthwise along its bottom side. Angles 386 and 388 are mounted back to back along slot 389 forming a linear orifice 390 sealed to and spanning the length of the gas knife. In the preferred embodiment, the linear orifice is approximately 0.04″ wide. As gas flows into gas knife 170a through threaded holes 384a and 384b, it flows out of the linear orifice to form a positive pressure curtain of gas along the length of the gas knife. In the preferred embodiment, a constant CO₂ gas flow of about 200 to 300 CFH is used for the gas knife distribution system. Gas knife 170b is constructed identically to gas knife 170a.

A gas knife distribution system 370 is provided to distribute gas to gas knives 170a and 170b. A pressurized gas reservoir 360 is connected by a gas line to gas control valve 361. Gas control valve 361 is further connected by a gas line to a gas regulator 377 which regulates the flow of gas into distribution system 370 and ultimately regulates the speed of gas flow out of the gas knives 170a and 170b. Gas knife distribution system 370 includes pipelines flow out of the gas knives 170a and 170b. Gas knife distribution system 370 includes pipelines connected by tee fittings 379a, 379b and 379c to the regulator by gas line 378. Gas knife distribution system 370 is connected to the gas knives by gas lines 371a and 371b and by flexible gas lines 372a and 372b.

FIGS. 1 and 3 best illustrate the location of the entry baffles, exit baffles, gas knives and reflective tray. Baffle plates 185a and 185b are attached between channels 110 and 111 and adjacent the entry and exit of the device. Baffle plates 185a and 185b limit stray UV light which escapes the unit to acceptable safety levels and further serve to insulate operators from hot components of the device. Gas knives 170a and 170b are positioned between baffle plates 185a and 185b and lamp supports 140a and 140b, respectively.

Reflective tray 350 is a generally flat rectangular polished pan having short sidewalls. Reflective tray 350 is mounted to table panel 115 centrally under both UV light assemblies and below roller bars 120. The reflective tray extends from the leading edge of UV light assembly 150a to the trailing edge of UV light assembly 150b and across the curing apparatus from channel 110 to channel 111. Reflective tray 350 has short sidewalls 351a and 351b which are situated so as to contain gas within the curing chamber. Reflective tray 350 serves a dual function. It provides a settling basin for the inert gas and a reflector for the UV radiation of the UV lamps during operation. The reflective tray is made of polished stainless steel. In other embodiments, polished aluminum is also used as are other, rigid, reflective and heat resistant materials.

Entry baffles 354a and 355a are steel angle mounted on table panel 115, beneath the roller bars and extend the width of the table from channel 110 to channel 111. Gas knife 170a is located above and adjacent entry baffle 354a. Exit baffles 354b and 355b are steel angle brackets mounted on panel 115 parallel to and beneath the roller bars and extend the width of the table from channel 110 to channel 111. Gas knife 170b is located above and adjacent exit baffle 354b. The entry baffles and exit baffles extend upward from table panel 115 toward the rollers. The entry and exit baffles are seated against the roller directly above each by a linear rubber gasket (not shown). The gas escaping from the gas knives flows downward toward and past the baffles and in conjunction with them prevents entry of oxygen into the curing chamber and the escape of inert gas from the curing chamber in the preferred embodiment.

As shown best in FIGS. 3 and 9, an oxygen sensor assembly is shown which comprises sensor input heads and an oxygen sensor connected by appropriate tubing. The role of oxygen sensor assembly 310 is to monitor the oxygen levels in the curing chamber. Oxygen sensor input heads 311a are attached by appropriate hollow standoffs 311b to elbow fittings 313a and 313b. Standoffs 311b protrude through reflective tray 350 near the midpoint between the channels to a height just below the bottom surface of objects 190 as they travel on the roller bars. Elbow fittings 313a and 313b attach to tubing 314a and 314b which in turn are attached to oxygen sensor 315. In the preferred embodiment, the oxygen sensor is a transducer that measures absence of oxygen in the atmosphere within the curing chamber. In the preferred embodiment, oxygen sensor head 315 is manufactured by Alpha Omega Instruments and is set to alarm when O₂ fraction by volume is less than 3%. In other embodiments, the percentage can be adjusted to assure that a properly inert atmosphere is in place, such as in high volume applications when many pieces are presented simultaneously. An electrical connection 318 from oxygen sensor head 315 to a sensor electronics unit 320 is also provided. The oxygen level result is displayed to the operator and sent to the control system. embodiment, the UV lamp is a single cylindrical tube being mechanically supported at each end by a socket. The UV lamp of the preferred embodiment of the present invention is a Mercury gas lamp which operates at a temperature of about 750 degrees Fahrenheit, has an arc length of approximately 52″ and draws about 7-8 kW of power. In the preferred embodiment, UV lamp is model number 530-300, supplied by Ultraviolet Systems, Ltd. of Houston, Tex., USA. In alternate embodiments, ultraviolet lamps having low, medium or high pressure gas can be used as well as doped lamps including amalgam, gallium or iron. In yet other embodiments ultraviolet arc lamps may be used. In other embodiments, other power ranges and gas mixtures can be utilized to cure different coatings.

A parabolic reflector 625 is fastened by screws 626 to lamp housing 600 and is made of polished stainless steel in the preferred embodiment. In other embodiments, polished aluminum can be used as well as other rigid, reflective and heat resistant materials. Heat sinks 620 and 622 are mounted on the upper surface of reflector 625 inside lamp cavity 601. Heat sinks 620 and 622 aid in the dispersal of heat from the reflector and from the lamp cavity 601 and are typically made of a copper alloy or aluminum. Of course, other alloys capable of efficient heat dissipation can be employed. The parabolic reflector acts to reflect light toward the curing chamber.

Flanges 627a and 627b are attached to lamp housing 600. The flanges provide support for heat shields 180b and 185a. The space between flanges 627a and 627b and the lamp support housing allows airflow from lamp cooling fans into the lamp region and through lamp cavity 601 via slots 628 in the reflector 625. Airflow is directed over heat sinks 620 and 622 and exhausted out of the UV lamp assembly 150b. In other embodiments, the slots can take the shape of round holes or angled vents.

Lamp hinge 151b includes a rotating joint 640 which is mounted to lamp housing 600 a similar lamp hinge 151a and rotating joint are connected on the opposite side of the lamp housing together the hinge and joints allow for the rotation of the entire UV lamp assembly 150b. UV lamp assembly 150b can be rotated by an angle of approximately 100° to an open position when the curing apparatus is not in operation. Rotating the lamp assembly 150b automatically stops operation of the curing apparatus and shuts down the UV lamp by opening a switch 645 which is electrically connected to a control unit (not shown).

UV lamp assembly 150a is constructed in the same way and operates in the same way as UV lamp assembly 150b, with the exception that UV lamp assembly 150a rotates in a direction opposite to that of UV lamp 150b. The two lamp assemblies both open outwards from the center of curing apparatus 100. In another embodiment, the lamp assemblies can open along axes parallel to the table or another axis as is convenient to accommodate UV lamp choices and cooling designs. Each lamp assembly has separate electrical connections and switches which are connected to a control unit (not shown).

The functions of the apparatus are controlled by a controller 700 which is physically located in separate standalone housing from the curing table in the preferred embodiment. The controller is connected to the gas control switch 361, gas solenoids 395a and 395b, drive motor 205, UV lamp assemblies 150a and 150b, cooling fans 152a and 152b, a start and stop switch 202, oxygen sensor 315 and switches 645. The standalone controller includes front access panel indicators 720 to indicate various states of the curing apparatus 100.

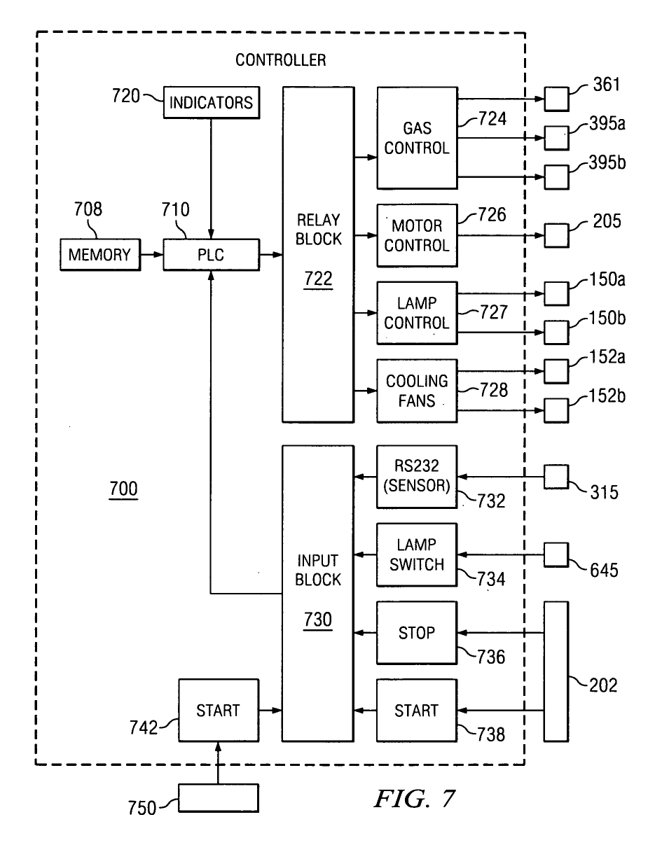

FIG. 7 shows the logical arrangement of controller 700. The functions of controller 700 are provided by a programmable logic controller 710. In the preferred embodiment, programmable logic controller 710 is a “PICO” type programmable logic controller available from Allen-Bradley of Milwaukee, Wis., USA. Of course, other programmable controllers such as a personal computer can be used in other embodiments. Hardwired controllers as well as discrete analog controllers may be employed in other embodiments. In the preferred embodiment, ladder logic is used to program the controller. Programmable logic controller 710 is connected to relay block 722. Relay block 722 includes circuitry to convert digital signals from programmable logic controller 710 into analog signals with sufficient current to drive the various peripheral devices required by the apparatus. Relay block 722 is connected to gas solenoids 395a and 395b through a gas control connection 724. Relay block 722 is connected to drive motor 205 through a motor control connection 726. Connection 726 includes a motor controller capable of starting and altering the speed of drive motor 205 and for applying sufficient current for that purpose.

Relay block 722 is also connected to UV lamps 150a and 150b through a connector 727 and to cooling fans 152a and 152b through a connector 728. Programmable logic controller 710 is also connected to input connector block 730. Input connector block 730 is capable of accepting analog or communication signals from the various peripheral devices required by the apparatus and converting them into digital signals accepted by programmable logic controller 710.

Input connector block 730 is connected by lamp switch connector 734 to oxygen level sensor 315 via RS232 connection 732. Programmable logic controller 710 converts the reported voltage to a percent oxygen level.

Input connector block 730 is also connected to switches 645, one for each UV lamp assembly, to indicate the open or closed position of the lamp assemblies.

Input connector block 730 is also connected to motor stop/start switch 202 via stop connection 736 and start connection 738. Also attached to input connector block 730 is numerical keypad 742 for entry of digital data by an operator 750, as required by the programmable logic controller to perform its functions.

Programmable logic controller 710 is also connected to durable memory 708. In the preferred embodiment, durable memory 708 is a battery backed up RAM. Of course, in other embodiments, durable memory 708 can be peripheral memory, magnetic or optical disk drives or network memory connected to the programmable logic controller through a network connection.

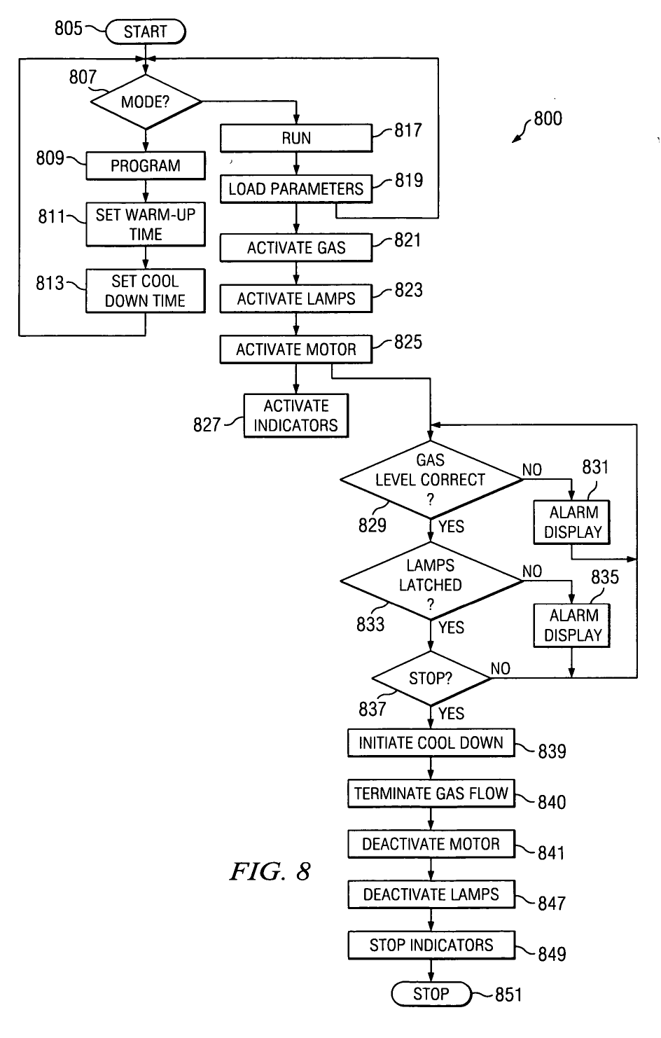

In operation, programmable logic controller 710 initiates a program 800, the steps of which are shown in FIG. 8, to operate the functions of the curing apparatus.

Referring then to FIG. 8, the program 800 is initiated at start block 805. As a first mode selection step 807, the program requires input to determine if it should enter run mode 817 or program mode 809. Upon entry into program mode 809, several parameters are required to be set for the operation of the curing apparatus. Initially, a timer is set to delay startup until the lamps have reached operational temperature. Program mode 809 then requires an input step to supply the warm-up time 811 and input step 813 to supply a cool-down time 813 for the UV lamps. Other parameters such as the speed of the table rollers, rates of gas flow, curing time and automatic start and stop times can be programmed in other embodiments. Upon proper entry of the required data parameters, the program returns to mode selection step 807.

Upon entry into run mode at 817, the program loads the parameters previously input in program mode. If the parameters are not present, the program returns to mode selection 807. If program parameters are present, the program activates the apparatus by first activating gas control switch 361 and solenoids 395 to initiate gas flow at step 821. When gas flow is activated, inert gas from gas reservoir 360 is admitted to gas distribution assemblies 160a, 160b and 170 through gas control switch 361. Once the gas enters the gas manifolds, the gas is distributed through the gas manifolds and enters the curing chamber. The inert gas, being heavier than air, fills the curing chamber. Consequently, the inert gas displaces the oxygen and other gases present in the curing chamber before operation of the apparatus. After the step 821, gas flow region 353 provides an oxygen free environment within curing apparatus 100.

At step 823, the program activates UV lamp assemblies 150a and 150b including the UV lamps and lamp cooling fans. Depending on the type of lamp used, a warm-up period may be required. A delay is instituted as programmed in the parameters to allow the UV lamps 605 to rise to operating temperature. Upon activation of the UV lamps at step 823, the program also activates the cooling fans. Once at operating temperature, UV lamps 605 produce an intense ultraviolet light which is reflected from each of the lamp reflectors 625 and from the surface of reflective pan 350 resulting in a high ultraviolet light intensity in the curing chamber. In the preferred embodiment a warm-up time for the UV lamps is set between 3 and 5 minutes.

At step 825, the program activates drive motor 205 and sends an activation indicator to the display at step 827. Its speed is adjusted by motor controller 726 to correspond with the desired speed of the material to be cured. Drive motor 205 in turn activates reduction gearbox 210 and primary drive chain 230 to motivate the drive chain 220. Simultaneously, the program sends a message through programmable logic controller 710 to display 720 to indicate a “run” condition indicating that the curing apparatus is functioning.

In use, one or more polymer coated objects are placed on the table roller bars 120 at the entrance 101 automatically or by an operator. The objects are moved by the roller bars under baffle 185a and through the gas curtain provided by air knife 170a into the curing chamber. The objects then track under the UV lights and pass between lamp assemblies 150a and 150b and the reflective pan 350 and are illuminated by the UV light generated from UV lamps 605.

While in the curing chamber, the ultraviolet sensitive coating on the object cures. In the preferred embodiment, the product is immersed the inert gas in the curing chamber and underneath the UV lamps for approximately 20 to 30 seconds. Of course, this time period can be adjusted by adjusting the speed of drive motor 205. In one embodiment, the cycle provided by the drive motor is continuous, but in others a delay may be instructed, momentarily halting progress of the objects while they are under the UV lamps.

After being cured the objects move past gas knife 170b, out of the curing chamber and past baffle plate 185b. As the objects 190 exit they are removed by an operator or proceed to another production area from the curing apparatus 100.

During continuous operations of the apparatus, the program enters a loop after step 825, starting at step 829 by checking oxygen sensor 315 to determine if the curing chamber is indeed completely filled with inert gas. In one preferred embodiment, the voltage output of oxygen sensor 325 is used as a threshold to begin operation of the process. In another preferred embodiment, the voltage output of oxygen sensor 325 is variable and is used by programmable logic controller 710 to proportionately open or close gas solenoids 395a and 395b via gas controller 724. If the oxygen reported by oxygen sensor 315 is high, programmable logic controller 710 opens solenoids 395a and 395b proportionately to allow more inert gas to enter gas flow region 353. As the level of oxygen drops, oxygen sensor 315 proportionately reduces voltage read by programmable logic controller 710. At a certain voltage minimum, an alarm display is sent to indicator 720 by programmable logic controller 710 at step 831. If the gas level is sufficient, then the program checks to assure that switches 645 are closed at step 833. If not, an alarm is sent from programmable logic controller 710 to display 720 at step 835. If both switches are indeed closed, the program proceeds to step 837. At step 837, programmable logic controller 710 polls the input connector block 730 to determine if stop switch 736 has been activated. If not, the loop returns, repeating step 829 and following steps, allowing continuous function of the curing apparatus.

If the stop switch 736 has been activated, then a cool-down procedure is initiated at step 839. Upon initiating cool-down, gas flow is terminated at step 840 by deactivating solenoids 395a and 395b. At step 841, drive motor 205 is deactivated through a gradual slowing of its speed to zero to avoid an instantaneous stop. Once the motor has been deactivated, the program deactivates the UV lamps 605 at step 847. The cooling fans 152a and 152b are allowed to run for the time indicated by the parameters 819 as set by step 813 in program mode 809. After cool-down time, at step 849, the display is sent a “stop” message indicating a stop condition of the apparatus and the program terminates at step 851. After step 851, a loop is entered, checking for start condition 738 which will then return the program to step 805.

In an alternate embodiment, the steps carried out by programmable logic controller 710 in program 800 can be accomplished manually. In this process, the drive motor and gas valves (or solenoids) are manually activated. Gas level 207 is maintained in gas flow region 353 by a hand held sensor device suitable for monitoring O₂ levels or alternately, the inert gas levels.

This invention is susceptible to considerable variation in its practice. Accordingly, this invention is not limited to the specific exemplifications set forth herein above. Rather, this invention is within the spirit and scope of the appended claims, including the equivalents thereof available as a matter of law.

The patentees do not intend to dedicate any disclosed embodiments to the public, and to the extent any disclosed modifications or alterations may not literally fall within the scope of the claims, they are considered to be part of the invention under the doctrine of equivalents.

1. A device for curing light sensitive coatings on parts comprising:
a supporting frame;
a dynamically sealed curing chamber;
a gas purge system, operationally connected to the curing chamber, for providing an atmosphere of predetermined composition; and
a UV radiation source adjacent the curing chamber and pivotally removable from the curing chamber.

2. The device of claim 1 wherein the dynamically sealed curing chamber comprises:
a containment pan;
an entry gas knife providing a positive pressure gas entry curtain; and
an exit gas knife providing a positive pressure gas exit curtain.

3. The device of claim 2 wherein the curing chamber further comprises a transparent window adjacent the UV radiation source.

4. The device of claim 2 wherein the positive pressure gas entry curtain has a flow rate of between 300 and 500 CFS.

5. The device of claim 2 wherein the positive pressure gas exit curtain has a flow rate of between 300 and 500 CFS.

6. The device of claim 1 wherein the predetermined composition has an oxygen level of less than about 5%.

7. The device of claim 1 wherein the UV radiation source is a UV lamp.

8. The device of claim 1 wherein the UV lamp is rated at about 100 to about 500 watts.

9. The device of claim 1 wherein the driver carriage comprises a plurality of rollers and at least one roller having a source of powered rotation.

10. The device of claim 9 wherein the curing chamber is bounded by a containment baffle in sliding relation to at least one roller.

11. The device of claim 9 wherein the driver carriage comprises a driver belt in contact with the plurality of rollers.

12. The device of claim 1 wherein the UV radiation source includes a parabolic reflector to direct radiation toward the curing chamber and a heat sink attached to the parabolic reflector.

13. The device of claim 1 wherein the UV radiation source includes a forced air cooling system.

14. The device of claim 1 wherein the UV radiation source further comprises at least one removable heat shield adjacent the UV radiation source.

15. The device of claim 1 wherein the gases purge system includes an oxygen sensor.

16. The device of claim 1 wherein the gases purge system includes a distribution manifold.

17. The device of claim 1 wherein the curing chamber is substantially flat.

18. A method of curing a light sensitive coating on a part including the steps of:
Providing a curing chamber with a predetermined gas composition;
Passing the part through an entry gas knife into the curing chamber;
Irradiating the part with UV radiation within the curing chamber; and
Passing the part through an exit gas knife out of the curing chamber.

19. The method of claim 18 comprising the further steps of:
Providing a source of UV radiation; and
rotating the source of UV radiation out of the curing chamber.

20. The method of claim 1 including the further steps of:
sensing the composition of a gas composition within the curing chamber; and
altering the gas composition within the curing chamber to match the predetermined composition.

21. The method of claim 1 wherein the step of providing further comprises providing a curing chamber that is substantially flat.

22. An apparatus for curing a coated article comprising:
a sealed housing having an entrance portal, an exit portal and a curing chamber;
a conveyor extending into the entrance portal, through the curing chamber and out of the exit portal;
a driver motor engaging the conveyor and configured to move the conveyor;
a heavy gas supply connected to the housing and configured to fill the curing chamber with heavy gas; and
a pivitally removable light source attached to the housing and directed toward the curing chamber.

23. The apparatus of claim 22, wherein the curing chamber is at the same the level as the entrance portal and the exit portal.

24. The apparatus of claim 22 wherein the driver motor is of variable speed.

25. The apparatus of claim 22 wherein the heavy gas is CO₂.

26. The apparatus of claim 22 wherein the heavy gas is noble gas.

27. The apparatus of claim 22 wherein the removable light source is supported by a pivoting frame adjacent the curing chamber.

28. The apparatus of claim 22 wherein the removable light source includes an internally facing reflector.

29. The apparatus of claim 22 wherein the removable light source produces ultraviolet light.

30. The apparatus of claim 22 wherein the removable light source includes an ultraviolet lamp tube.

31. The apparatus of claim 22 wherein the removable light source includes an ultraviolet arc lamp.

32. The apparatus of claim 22 wherein the heavy gas supply includes a gas level sensor configured to report a signal when the heavy gas fills the curing chamber.

33. The apparatus of claim 32 wherein the signal represents an O₂ concentration of less than 5% by volume.

34. A controller for coordinating steps for curing products in a heavy gas comprising:
a microcontroller;
a memory connected to the microcontroller;
a display connected to the microcontroller;
an analog to digital connector connected to the microcontroller, having outputs to drive a gas control solenoid, a driver motor and an ultraviolet light source;
the microcontroller programmed to carry out the following steps:
activate heavy gas flow to a curing chamber;
activate the ultraviolet light source; and,
activate the driver motor.

35. The controller of claim 34 wherein the microcontroller is programmed to carry out the additional stops of:
reading the gas level from a gas level sensor;
if the gas level is below a predetermined level, sending an alarm to a display;
reading a lamp sensor;
if the lamp sensor reports a lamp open signal, then sending an alarm to the display.

36. The controller of claim 34 wherein the microcontroller is programmed to carry out the additional steps of:
closing the gas control solenoid;
deactivating the driver motor; and
deactivating the ultraviolet lamp.

37. The controller of claim 36 programmed to deactivate the driver motor by a controlled slowing.

38. The controller of claim 36 wherein the step of deactivating the ultraviolet lamp comprises the step of:
maintaining current to a cooling fan for a predetermined time; and
deactivating current to the cooling fan.

39. The controller of claim 34, further programmed to
enter a program mode;
accept input from a digital keypad comprising a speed for the driver motor, a cool-down time for the ultraviolet lamp and a gas rate for the gas solenoid; and
storing the input in the memory.

40. The controller of claim 34 wherein the microcontroller is a programmable logic device.

41. The controller of claim 34 wherein the microcontroller is a personal computer.
